(19) United States
(12) Patent Application Publication
(10) Pub. No.: US 2024/0222000 A1
(43) Pub. Date: Jul. 4, 2024

(54) INSULATION ASSEMBLY, TRANSFORMER ASSEMBLY, AND DRY TYPE TRANSFORMER

(71) Applicant: Hitachi Energy Ltd, Zurich (CH)

(72) Inventors: QingJun SUN, Shanghai (CN); QiongFang Lu, Shanghai (CN); Ye Xu, Shanghai (CN); YuSong Yang, Shanghai (CN)

(73) Assignee: Hitachi Energy Ltd, Zurich (CH)

(21) Appl. No.: 17/766,657

(22) PCT Filed: Nov. 1, 2019
(86) PCT No.: PCT/CN2019/114983

§ 371 Date: Apr. 5, 2022

(51) Int. Cl. H01F 27/32; H01F 27/08

(52) U.S. Cl. CPC H01F 27/324; H01F 27/085; H01F 27/322

(57) ABSTRACT

Embodiments relate to an insulation assembly for use in a transformer, a transformer assembly for use in a transformer, and a dry type transformer. The insulation assembly includes a plurality of tubular insulation barriers adapted to be arranged around a transformer inner coil to electrically isolate the inner coil from a transformer outer coil, each pair of adjacent tubular insulation barriers being separated by a gap; and an air blocking element arranged in at least one gap between the plurality of tubular insulation barriers to at least partially block an air flow from passing through the at least one gap. According to various embodiments, the air blocking element blocks the cool air from passing through the at least one gap. Thus, more cool air may pass through gas channels near to the inner/outer coils and take away more heat generated by the transformer, thereby improving the cooling efficiency of the transformer.

### CROSS-REFERENCE TO RELATED APPLICATIONS

The present application is a 35 U.S.C. 371 National Stage patent application of International patent application PCT/CN2019/114983, filed on Nov. 1, 2019, the disclosure and content of which is incorporated by reference herein in its entirety.

### TECHNICAL FIELD

Embodiments of present disclosure generally relate to the field of transformers, and more particularly, to an insulation assembly for use in a transformer, a transformer assembly for use in a transformer, and a dry type transformer.

### BACKGROUND

When a dry type transformer operates, heat generated by high and low voltage coils of the transformer needs be dissipated timely so as to avoid overheating and insulation damage of the transformer. The dry type transformer may be cooled in various manners, such as air-forced (AF) cooling or air-forced water-forced (AFWF) cooling. In these cooling manners, cool air from a cooler is directed to go through channels in the transformer to take away the heat generated by the coils. In this way, temperature rise of the transformer may be controlled in a reasonable range according to different insulation classes.

The dry type transformer typically includes one or more transformer assemblies. Each transformer assembly includes a core, an inner coil, an outer coil, and an insulation assembly arranged between the inner and outer coils to electrically isolate the inner coil from the outer coil. The insulation assembly is spaced apart from the inner and outer coils and includes a plurality of insulation barriers arranged to be coaxial with each other. Each pair of adjacent insulation barriers are separated by a gap. In this way, the cool air is divided into three paths to go through each transformer assembly, i.e., one near to the inner coil, one through the gap between the insulation barriers, and one near to the outer coil. The cool air in the paths near to the inner and outer coils may effectively take away the heat generated by the coils. However, since the cool air through the gap between the insulation barriers is far away from the inner and outer coils, it cannot take away much heat during operation of the transformer. In other words, the cool air through the gap between the insulation barriers is essentially useless for cooling the inner and outer coils, reducing cooling efficiency of the transformer.

Therefore, there is a need to improve the cooling efficiency of the dry type transformer.

### SUMMARY

Example embodiments of the present disclosure provide solutions for improving the cooling efficiency of the dry type transformer.

In a first aspect of the present disclosure, example embodiments of the present disclosure provide an insulation assembly for use in a transformer. The insulation assembly comprises a plurality of tubular insulation barriers adapted to be arranged around an inner coil of the transformer to electrically isolate the inner coil from an outer coil of the transformer, each pair of adjacent tubular insulation barriers being separated by a gap; and an air blocking element arranged in at least one gap between the plurality of tubular insulation barriers to at least partially block an air flow from passing through the at least one gap.

In some embodiments, the air blocking element is arranged at a position away from both ends of the plurality of tubular insulation barriers.

In some embodiments, the air blocking element is arranged in the middle of both ends of the plurality of tubular insulation barriers.

In some embodiments, the air blocking element is of a ring shape.

In some embodiments, the air blocking element is provided with one or more openings.

In some embodiments, the air blocking element is coupled to the corresponding tubular insulation barriers via fastening elements.

In some embodiments, the fastening elements comprise plastic screws.

In some embodiments, the air blocking element is arranged in each gap between the plurality of tubular insulation barriers.

In some embodiments, the air blocking element is made of a plastic material.

In a second aspect of the present disclosure, example embodiments of the present disclosure provide a transformer assembly for use in a transformer. The transformer assembly comprises a core; an inner coil arranged around the core; an outer coil arranged around the inner coil; and an insulation assembly according to the first aspect of the present disclosure arranged between the inner and outer coils, an innermost one of the plurality of tubular insulation barriers being spaced apart from the inner coil to form a first gas channel, and an outermost one of the plurality of tubular insulation barriers being spaced apart from the outer coil to form a second gas channel.

In some embodiments, the inner coil is a low voltage coil and the outer coil is a high voltage coil.

In a third aspect of the present disclosure, example embodiments of the present disclosure provide a dry type transformer. The dry type transformer comprises a first housing provided with a first air inlet and a first air outlet; one or more transformer assemblies according to the second aspect of the present disclosure arranged in the first housing; and a cooler. The cooler comprises a second housing provided with a second air inlet in fluid communication with the first air outlet and a second air outlet in fluid communication with the first air inlet; a heat exchanger arranged in the second housing to cool the air in the second housing; and a fan arranged in the second housing to circulate the air between the first and second housings.

According to various embodiments of the present disclosure, the air blocking element is provided in at least one gap between the tubular insulation barriers so as to block the cool air from passing through the at least one gap. In this way, more cool air may pass through gas channels near to the inner and outer coils and take way more heat generated by the transformer, improving the cooling efficiency of the transformer.

Moreover, in the dry type transformer according to embodiments of the present disclosure, since the cool air may take way more heat generated by the transformer, the temperature of the air transferred from the first housing into the cooler would be increased. As such, hotter air enters the cooler and more power may be dissipated by the cooler. Eventually, the blocking of the gap between the tubular insulation barriers effectively improves the cooling performance of the transformer, reduces the temperature rise and is cost competitive.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 illustrates a schematic view of a conventional dry type transformer;

FIG. 2 illustrates a cross-sectional view of a conventional transformer assembly for use in the dry type transformer as shown in FIG. 1;

FIG. 3 illustrates a top view of the transformer assembly as shown in FIG. 2;

FIG. 4 illustrates a cross-sectional view of a transformer assembly for use in the transformer in accordance with an embodiment of the present disclosure;

FIG. 5 illustrates a top view of the transformer assembly as shown in FIG. 4;

FIG. 6 illustrates a cross-sectional view of a transformer assembly for use in the transformer in accordance with another embodiment of the present disclosure;

FIG. 7 illustrates a top view of the transformer assembly as shown in FIG. 6; and

FIG. 8 illustrates a top view of a transformer assembly for use in the transformer in accordance with yet another embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Unless specified or limited otherwise, the terms “mounted.” “connected.” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the figures. Other definitions, explicit and implicit, may be included below.

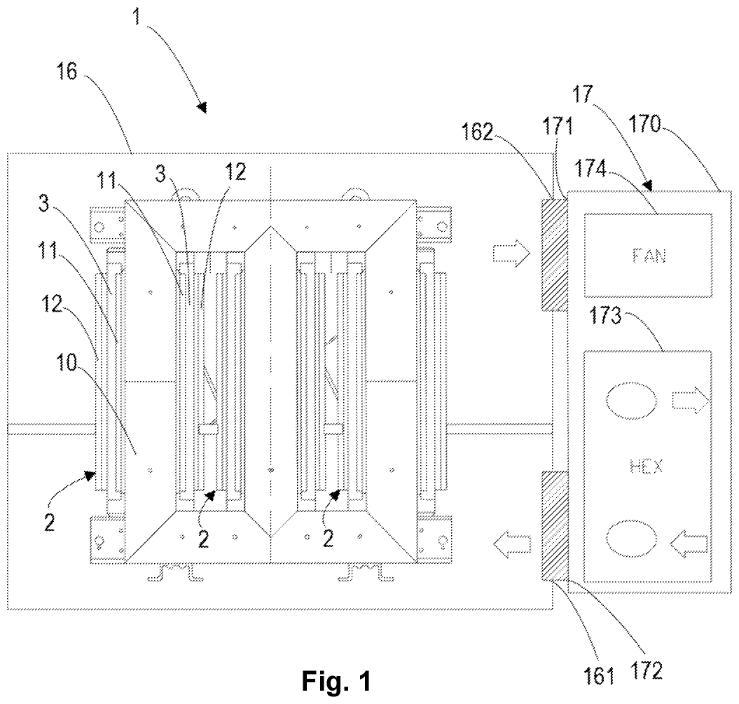

FIG. 1 illustrates a schematic view of a conventional dry type transformer 1. As shown, the transformer 1 includes a first housing 16, one or more transformer assemblies 2 arranged in the first housing 16, and a cooler 17 in fluid communication with the first housing 16. Each transformer assembly 2 includes a core 10, an inner coil 11, an outer coil 12, and an insulation assembly 3. The inner coil 11 is arranged around the core 10. The outer coil 12 is arranged around the inner coil 11. The insulation assembly 3 is arranged between the inner and outer coils 11, 12 so as to electrically isolate the inner coil 11 from the outer coil 12. The first housing 16 is provided with a first air inlet 161 and a first air outlet 162 so as to receive cool air from the cooler 17 and transfer hot air into the cooler 17.

The transformer assemblies 2 are cooled in an air-forced water-forced (AFWF) cooling manner. The cooler 17 includes a second housing 170, a heat exchanger 173, and a fan 174. The second housing 170 is provided with a second air inlet 171 in fluid communication with the first air outlet 162 and a second air outlet 172 in fluid communication with the first air inlet 161. The cool air is supplied from the second housing 170 into the first housing 16 via the second air outlet 172 and the first air inlet 161. Inside the first housing 16, the air is heated by the transformer assemblies 2. The hot air is discharged from the first housing 16 into the second housing 170 via the first air outlet 162 and the second air inlet 171.

In some embodiments, as shown in FIG. 1, the heat exchanger 173 is arranged in the second housing 170 near to the second air outlet 172 so as to cool the air in the second housing 170 and provide the cool air. In other embodiments, the heat exchanger 173 may be arranged at other positions in the second housing 170. The scope of the present disclosure is not intended to be limited in this respect. The exchanger 173 may cool the air in the second housing 170 through cool water circulation.

In some embodiments, as shown in FIG. 1, the fan 174 is arranged in the second housing 170 near to the second air inlet 171 to circulate the air between the first and second housings 16, 170. In other embodiments, the fan 174 may be arranged at other positions in the second housing 170. The scope of the present disclosure is not intended to be limited in this respect.

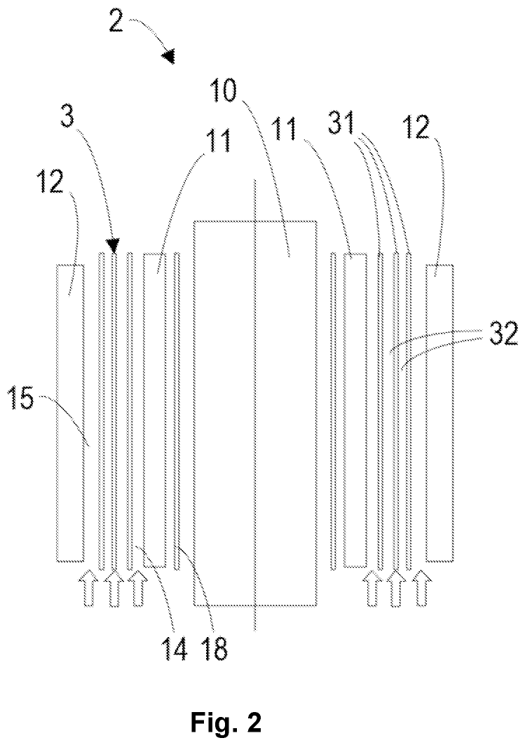

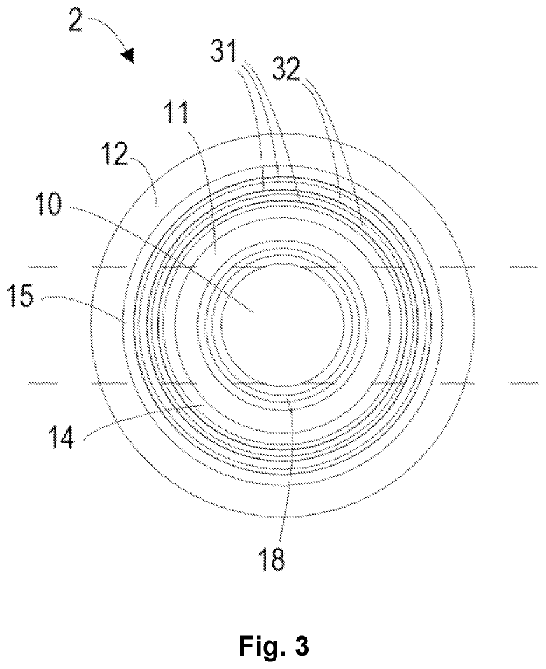

FIG. 2 illustrates a cross-sectional view of a conventional transformer assembly 2 for use in the dry type transformer 1 as shown in FIG. 1, and FIG. 3 illustrates a top view of the transformer assembly 2 as shown in FIG. 2. As shown in FIGS. 2 and 3, the transformer assembly 2 includes a core 10, an inner coil 11, an outer coil 12, and an insulation assembly 3. The inner coil 11 is arranged around the core 10. The outer coil 12 is arranged around the inner coil 11. The insulation assembly 3 is arranged between the inner and outer coils 11, 12. The insulation assembly 3 includes three insulation barriers 31 arranged around the inner coil 11. Each pair of adjacent insulation barriers 31 are separated by a gap 32. An innermost one of the insulation barriers 31 is spaced apart from the inner coil 11 to form a first gas channel 14. An outermost one of the insulation barriers 31 is spaced apart from the outer coil 12 to form a second gas channel 15.

In some embodiments, the inner coil 11 is a low voltage coil and the outer coil 12 is a high voltage coil. In other embodiments, the inner coil 11 is a high voltage coil and the outer coil 12 is a low voltage coil. Each of the inner and outer coils 11, 12 may include one or more portions. The scope of the present disclosure is not intended to be limited in this respect.

In some embodiments, an additional insulation layer 18 may be provided between the inner coil 11 and the core 10.

As shown in FIGS. 2 and 3, when the cool air passes through the transformer assembly 2 in a direction indicated by arrows, the cool air is divided into three paths to go through the transformer assembly 2, i.e., the first gas channel 14 near to the inner coil 11, the gap 32 between the tubular insulation barriers 31, and the second gas channel 15 near to the outer coil 12. The cool air in the first and second gas channels 14, 15 may effectively take away the heat generated by the inner and outer coils 11, 12. However, since the cool air through the gap 32 between the tubular insulation barriers 31 is far away from the inner and outer coils 11, 12, it cannot take away much heat during operation of the transformer 1, reducing the cooling efficiency of the transformer 1.

According to embodiments of the present disclosure, to improve the cooling efficiency of the dry type transformer 1, an air blocking element 33 is provided in at least one gap 32 between the tubular insulation barriers 31 so as to at least partially block an air flow from passing through the at least one gap 32. The above idea may be implemented in various manners, as will be described in detail in the following paragraphs.

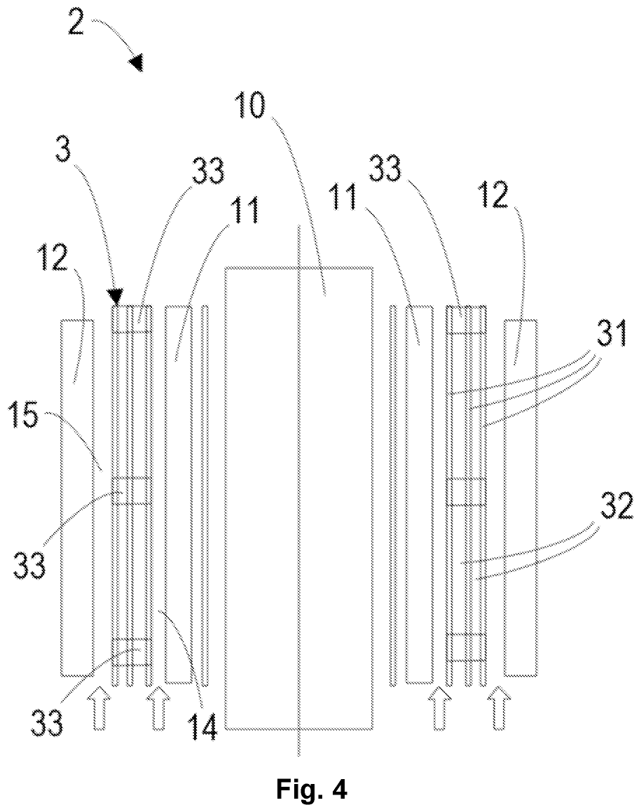

Hereinafter, the principles of the present disclosure will be described in detail with reference to FIGS. 4-8.

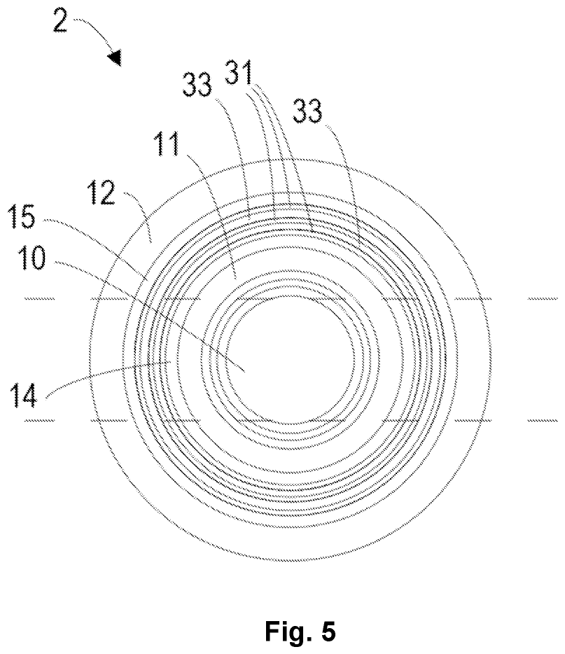

Referring to FIGS. 4 and 5 first, FIG. 4 illustrates a cross-sectional view of a transformer assembly 2 for use in the transformer 1 in accordance with an embodiment of the present disclosure, and FIG. 5 illustrates a top view of the transformer assembly 2 as shown in FIG. 4. As shown in FIGS. 4 and 5, the transformer assembly 2 includes a core 10, an inner coil 11, an outer coil 12, and an insulation assembly 3 arranged between the inner and outer coils 11, 12. The arrangement of the core 10, the inner coil 11, the outer coil 12, and the insulation assembly 3 as shown in FIGS. 4 and 5 is similar to that of the core 10, the inner coil 11, the outer coil 12, and the insulation assembly 3 as shown in FIGS. 2 and 3, and would not be described in detail here.

As shown in FIGS. 4 and 5, the insulation assembly 3 includes three tubular insulation barriers 31 arranged around the inner coil 11. Each pair of adjacent tubular insulation barriers 31 are separated by a gap 32. An innermost one of the tubular insulation barriers 31 is spaced apart from the inner coil 11 to form a first gas channel 14. An outermost one of the tubular insulation barriers 31 is spaced apart from the outer coil 12 to form a second gas channel 15.

In addition to the tubular insulation barriers 31, the insulation assembly 3 further includes an air blocking element 33 for at least partially blocking the air flow from passing through at least one gap 32 between the tubular insulation barriers 31. By means of the air blocking element 33, the gas flow path through at least one gap 32 may be at least partially blocked. In this way, more cool air would pass through the gas channels 14 and 15 near to the inner and outer coils 11 and 12 and take way more heat generated by the transformer 1, thus improving the cooling efficiency of the transformer 1.

In some embodiments, as shown in FIGS. 4 and 5, the air blocking element 33 is arranged in each gap 32 between the three tubular insulation barriers 31 to completely block the gas flow path between the tubular insulation barriers 31. In other embodiments, the air blocking element 33 may be arranged in only a portion of gaps 32 to partially block the gas flow path between the tubular insulation barriers 31. For example, the air blocking element 33 may be arranged in only one of the gaps 32. Likewise, such an arrangement may render more cool air to pass through the gas channels 14 and 15 near to the inner and outer coils 11 and 12 and take way more heat generated by the transformer 1.

According to embodiments of the present disclosure, the air blocking element 33 may be arranged at various positions in the gap 32. FIG. 4 illustrates three example positions of the air blocking element 33. In some embodiments, the air blocking element 33 may be arranged at either end (for example, an upper end, as shown) of the tubular insulation barriers 31.

In other embodiments, the air blocking element 33 may be arranged at a position away from both ends of the tubular insulation barriers 31. In other words, the air blocking element 33 is arranged at a distance from either end of the tubular insulation barriers 31. In some embodiments, the distance may be larger than a predetermined value, for example 20 mm. With such an arrangement, a creepage distance between the inner and outer coils 11 and 12 would be substantially unaffected. In an example, the air blocking element 33 may be arranged in the middle of both ends of the tubular insulation barriers 31. In this case, the effect of the air blocking element 33 on the creepage distance between the inner and outer coils 11 and 12 may be minimized.

In some embodiments, as shown in FIGS. 4 and 5, the air blocking element 33 is of a ring shape. In this case, the air blocking element 33 may completely block the corresponding gap 32. In other embodiments, the air blocking element 33 may be of other shapes. As an example, the air blocking element 33 may include multiple uncontinuous portions arranged in the gap 32.

In some embodiments, the air blocking element 33 is coupled to the corresponding tubular insulation barriers 31 via fastening elements (not shown). The fastening elements may be plastic screws or other types. The scope of the present disclosure is not intended to be limited in this respect.

In some embodiments, the air blocking element 33 is made of a plastic material, such as rubber. In other embodiments, the blocking element 33 may be made of other insulation materials. The scope of the present disclosure is not limited in this respect.

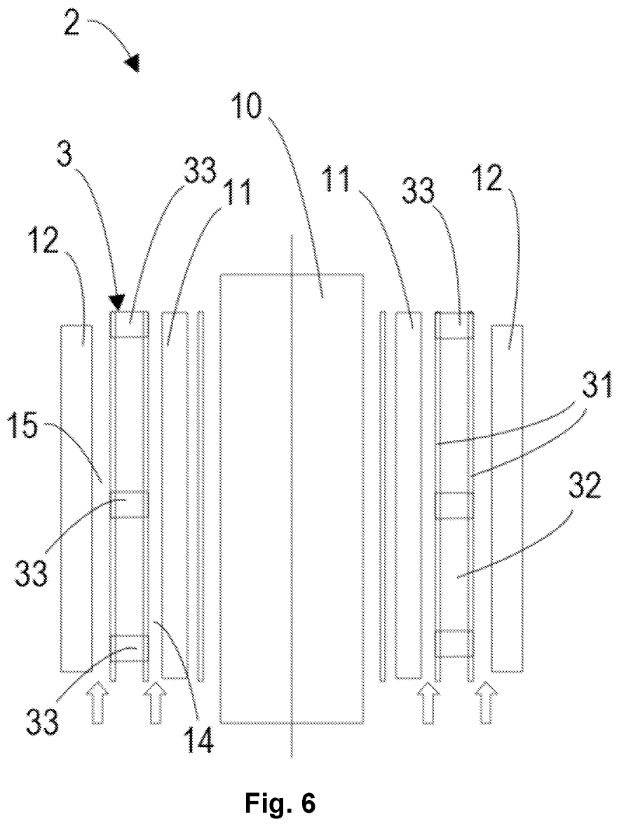

FIG. 6 illustrates a cross-sectional view of a transformer assembly 2 for use in the transformer 1 in accordance with another embodiment of the present disclosure, and

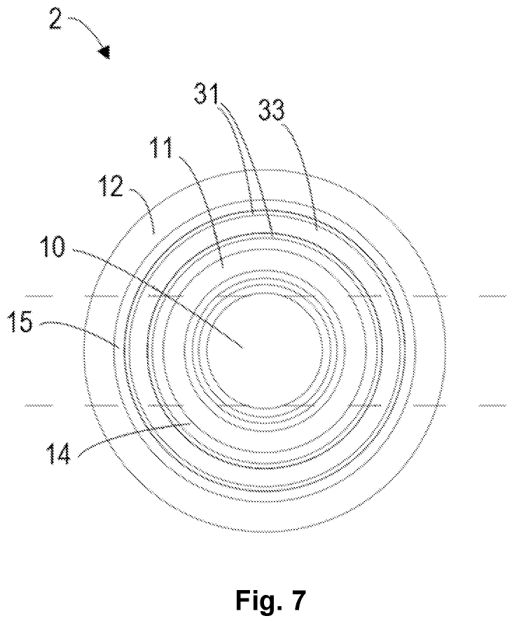

FIG. 7 illustrates a top view of the transformer assembly 2 as shown in FIG. 6. The construction of the transformer assembly 2 as shown in FIGS. 6 and 7 is similar to that of the transformer assembly 2 as shown in FIGS. 4 and 5, except that the transformer assembly 2 as shown in FIGS. 6 and 7 includes two tubular insulation barriers 31 arranged around the inner coil 11. The air blocking element 33 may be arranged at various positions in the gap 32 between the two tubular insulation barriers 31 so as to block the air flow from passing through the gap 32.

It is to be understood that the transformer assembly 2 including two or three tubular insulation barriers 31 is only uses as an example for ease of illustrating the principles of the present disclosure. In other embodiments, the transformer assembly 2 may include more than three tubular insulation barriers 31 arranged around the inner coil 11.

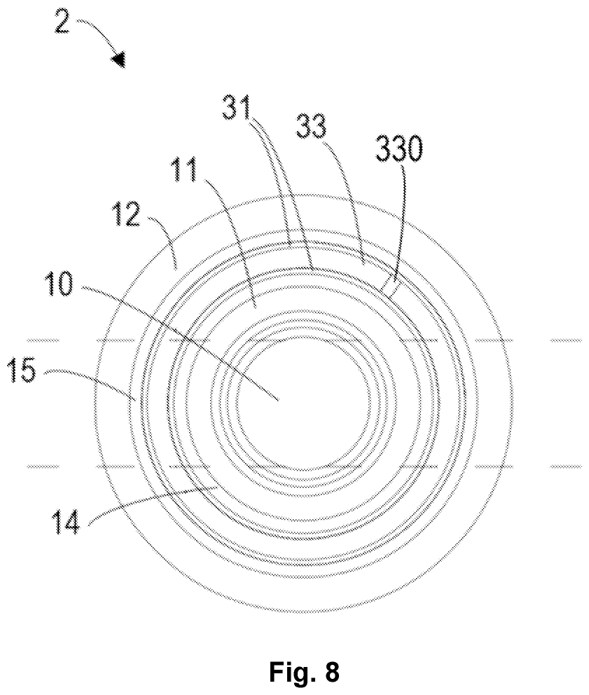

FIG. 8 illustrates a top view of a transformer assembly 2 for use in the transformer 1 in accordance with yet another embodiment of the present disclosure. The construction of the transformer assembly 2 as shown in FIG. 8 is similar to that of the transformer assembly 2 as shown in FIGS. 6 and 7, except that the air blocking element 33 of the transformer assembly 2 as shown in FIG. 8 is provided with one or more openings 330. During the operation of the transformer 1, water vapor in the first housing 16 may condensate into water droplets when it encounters the cool air from the cooler 17. The water droplets would aggregate onto the air blocking element 33. Through the openings 330 on the air blocking element 33, the water droplets may flow out of the transformer assembly 2 so as to avoid insulation damage of the transformer 1.

According to various embodiments of the present disclosure, the air blocking element 33 is provided in at least one gap 32 between the tubular insulation barriers 31 so as to block the cool air from passing through the at least one gap 32. In this way, more cool air may pass through the gas channels 14, 15 near to the inner and outer coils 11, 12 and take way more heat generated by the transformer 1, improving the cooling efficiency of the transformer 1.

Moreover, in the dry type transformer 1 according to embodiments of the present disclosure, since the cool air may take way more heat generated by the transformer 1, the temperature of the air transferred from the first housing 16 into the cooler 17 would be increased. As such, hotter air enters the cooler 17 and more power may be dissipated by the cooler 17. Therefore, the blocking of the gap 32 between the tubular insulation barriers 31 effectively improves the cooling performance of the transformer 1, reduces the temperature rise and is cost competitive.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An insulation assembly for use in a transformer, comprising:
a plurality of tubular insulation barriers adapted to be arranged around an inner coil of the transformer to electrically isolate the inner coil from an outer coil of the transformer, each pair of adjacent tubular insulation barriers being separated by a gap; and
an air blocking element arranged in at least one gap between the plurality of tubular insulation barriers to at least partially block an air flow from passing through the at least one gap.

2. The insulation assembly according to claim 1, wherein the air blocking element is arranged at a position away from both ends of the plurality of tubular insulation barriers.

3. The insulation assembly according to claim 2, wherein the air blocking element is arranged in the middle of both ends of the plurality of tubular insulation barriers.

4. The insulation assembly according to claim 1, wherein the air blocking element is of a ring shape.

5. The insulation assembly according to claim 4, wherein the air blocking element is provided with one or more openings.

6. The insulation assembly according to claim 1, wherein the air blocking element is coupled to the corresponding tubular insulation barriers via fastening elements.

7. The insulation assembly according to claim 6, wherein the fastening elements comprise plastic screws.

8. The insulation assembly according to claim 1, wherein the air blocking element is arranged in each gap between the plurality of tubular insulation barriers.

9. The insulation assembly according to claim 1, wherein the air blocking element is made of a plastic material.

10. A transformer assembly for use in a transformer, comprising:
a core;
an inner coil arranged around the core;
an outer coil arranged around the inner coil; and
an insulation assembly arranged between the inner and outer coils, the insulation assembly comprising a plurality of tubular insulation barriers adapted to be arranged around the inner coil to electrically isolate the inner coil from the outer coil, each pair of adjacent tubular insulation barriers being separated by a gap and an air blocking element arranged in at least one gap between the plurality of tubular insulation barriers to at least partially block an air flow from passing through the at least one gap, an innermost one of the plurality of tubular insulation barriers being spaced apart from the inner coil to form a first gas channel, and an outermost one of the plurality of tubular insulation barriers being spaced apart from the outer coil to form a second gas channel.

11. The transformer assembly according to claim 10, wherein the inner coil is a low voltage coil and the outer coil is a high voltage coil.

12. A dry type transformer comprising:
a first housing provided with a first air inlet and a first air outlet;
one or more transformer assemblies arranged in the first housing, each transformer assembly of the one or more transformer assemblies comprising:
a core;
an inner coil arranged around the core;
an outer coil arranged around the inner coil; and
an insulation assembly arranged between the inner and outer coils, the insulation assembly comprising a plurality of tubular insulation barriers adapted to be arranged around the inner coil to electrically isolate the inner coil from the outer coil, each pair of adjacent tubular insulation barriers being separated by a gap and an air blocking element arranged in at least one gap between the plurality of tubular insulation barriers to at least partially block an air flow from passing through the at least one gap, an innermost one of the plurality of tubular insulation barriers being spaced apart from the inner coil to form a first gas channel, and an outermost one of the plurality of tubular insulation barriers being spaced apart from the outer coil to form a second gas channel; and
a cooler comprising:
a second housing provided with a second air inlet in fluid communication with the first air outlet and a second air outlet in fluid communication with the first air inlet;
a heat exchanger arranged in the second housing to cool the air in the second housing; and
a fan arranged in the second housing to circulate the air between the first and second housings.

13. The dry transformer according to claim 12, wherein the air blocking element is arranged at a position away from both ends of the plurality of tubular insulation barriers.

14. The dry transformer according to claim 13, wherein the air blocking element is arranged in the middle of both ends of the plurality of tubular insulation barriers.

15. The dry transformer according to claim 12, wherein the air blocking element is of a ring shape.

16. The dry transformer according to claim 15, wherein the air blocking element is provided with one or more openings.

17. The dry transformer according to claim 12, wherein the air blocking element is coupled to the corresponding tubular insulation barriers via fastening elements.

18. The dry transformer according to claim 17, wherein the fastening elements comprise plastic screws.

19. The dry transformer according to claim 12, wherein the air blocking element is arranged in each gap between the plurality of tubular insulation barriers.

20. The dry transformer according to claim 12, wherein the air blocking element is made of a plastic material.
